(19) United States
(12) Patent Application Publication
(10) Pub. No.: US 2013/0069257 A1
(43) Pub. Date: Mar. 21, 2013

(54) METHOD FOR MANUFACTURING OPTICAL ELEMENT, AND OPTICAL ELEMENT MOLDING DIE

(71) Applicants: Kazuyuki Ogura, Yao-shi (JP); Yoshihiro Kamada, Osaka-shi (JP)

(72) Inventors: Kazuyuki Ogura, Yao-shi (JP); Yoshihiro Kamada, Osaka-shi (JP)

(21) Appl. No.: 13/580,036

(22) PCT Filed: Feb. 3, 2011
(86) PCT No.: PCT/JP11/52234

§ 371 Date: Aug. 20, 2012

(30) Foreign Application Priority Data
Feb. 23, 2010 (JP) 2010-037272

(51) Int. Cl. B29D 11/00

(52) U.S. Cl. CPC B29D 11/00009; B29D 11/005
USPC 264/1.1; 425/150

(57) ABSTRACT

Provided is an optical element manufacturing method for manufacturing optical elements having opposing optical surfaces by using a pair of molding dies having molding surfaces, in which each molding die is provided with a molding surface for molding a first optical element and a molding surface for molding a second optical element, wherein the later molding surface is distinct from the former one and is used to adjust the relative positions of the pair of molding dies, and in which each molding die is used to perform the steps of: molding the second optical element; determining the misalignment between the opposing optical surfaces from the transmitted wavefront aberration of the second optical element; adjusting the relative position between the molding dies on the basis of the determined relative displacement; and molding the first optical element by using the molding dies, the relative position of which has been adjusted.

### TECHNICAL FIELD

The present invention relates to a method for manufacturing an optical element, and to an optical element molding die.

### BACKGROUND ART

Today, an optical element is widely used as a lens for digital cameras, an optical pickup lens for DVDs and the like, a camera lens for portable phone, a coupling lens for optical communications. These optical systems made up of optical elements are required to have high performance, and optical elements are accordingly required to be made more precisely than ever.

Such optical elements may be manufactured by a pressure molding method in which heated and softened glass material is pressure formed by a molding die.

In the pressure molding method, the molding surfaces of the molding die for forming opposing optical surfaces of an optical element is obviously made with high precision, and the relative position between the molding surfaces of the opposing molding dies need to be aligned with high precision.

In order to adjust the relative positions of the molding dies with high precision, the relative positions of the molding dies may be adjusted on the basis of the evaluation result of an optical element made by the molding dies, for example. For example, there is known a method in which the both lens surfaces of an optical lens are made to have a convex portion made up of a small protrusion on the optical axis, an amount of eccentricity between the both lens surfaces is obtained from the misalignment of the convex portions, and the relative position between the molding dies for molding the optical lens is adjusted on the basis of the amount of eccentricity (for example, see Patent Document 1).

### RELATED ART DOCUMENT

### Patent Document

Patent Document 1: Japanese Laid-Open Patent Application Publication No. 2006-58850

### SUMMARY OF THE INVENTION cl Object of the Invention

In the adjustment of the relative position between the molding dies described in Patent Document 1, the convex portions are made centering on the optical axis of the optical lens and are used for the adjustment. Thus, the optical performance of the obtained optical lens may be highly affected and the optical lens may not have sufficient performance when the diameter is small. In addition, it is necessary to form a recess corresponding to the convex portion in the molding die without affecting the molding surface for forming the optical surface of the optical lens, and a large burden is put on the manufacturing of the molding die.

The present invention has been made in view of the above-mentioned problem, and an object of the invention is to provide a method for manufacturing a high precision optical element and to provide a molding die for manufacturing a high precision optical element.

### Means for Solving the Object

The above-mentioned object is solved by the following configuration.

Item 1. A method for manufacturing an optical element wherein the optical element is formed by using a pair of molding dies having molding surfaces for forming the optical element having opposing optical surfaces, and wherein the molding dies have molding surfaces for forming a first optical element to be made by using the molding dies and molding surfaces which are different from the molding surfaces for forming the first optical element, and are used to form a second optical element to be used to adjust a relative position between the pair of molding dies, the method comprising the steps of:
a first molding step for forming the second optical element by using the molding dies;
a measurement step for obtaining a misalignment amount of a relative position of the opposing optical surfaces of the second optical element, based on a wavefront aberration of transmitted light of the second optical element molded in the first molding step;
a relative position adjusting step for adjusting the relative position between the pair of molding dies, based on the amount of relative position obtained in the measurement step; and
a second molding step for forming the first optical element by using the molding dies the relative position between which has been adjusted in the relative position adjusting step.

Item 2. The method of item 1 for manufacturing an optical element, wherein a displacement of a transmitted wavefront of a plane wave or a spherical wave having entered into the second optical element from a spherical surface closest to a designed transmitted wavefront of the second optical element is smaller than a displacement of a transmitted wavefront of a plane wave or a spherical wave having entered into the first optical element from a spherical surface closest to a designed transmitted wavefront of the first optical element.

Item 3. The method of item 1 for manufacturing an optical element, wherein a ratio of an amount of the wavefront aberration of transmitted light of the second optical element to a displacement of relative position of the opposing optical surfaces of the second optical element is greater than a ratio of an amount of a wavefront aberration of transmitted light of the first element to a displacement of relative position of the opposing optical surfaces of the second optical element.

Item 4. The method of any one of items 1 to 3 for manufacturing an optical element, wherein the wavefront aberration of transmitted light of the second optical element includes aberration generated due to at least one of parallel eccentricity and inclination eccentricity of the opposing optical surfaces.

Item 5. The method of item 1 or 3 for manufacturing an optical element, wherein the wavefront aberration of transmitted light of the second optical element include aberration generated by a relative rotation of the opposing surfaces around the optical axis of the second optical element.

Item 6. An optical element molding die, comprising:
molding surfaces for the first optical element and the second optical element used in the method of any one of items 1 to 5 for manufacturing an optical element.

### Advantage of the Invention

According to the present invention, the specifications of the second optical element can be determined just for adjustment, being independent of the specifications of the first optical element. Thus, the adjustment of the relative positions of the molding dies used to manufacture the first optical element can be done based on the wavefront aberration of transmitted light of the second optical element having specifications suitable for adjusting the relative positions of the molding dies, and the relative position can be adjusted with high precision. This arrangement provides a method and an optical element molding dies for manufacturing an optical element for highly precisely forming the first optical element without having a convex portion and the like, which affects the optical performance.

### BRIEF DESCRIPTION OF THE DRAWINGS

FIG. 1 is a diagram showing molding dies for molding optical elements;

FIG. 2a is a cross section of the lower mold of FIG. 1 along the line G-G′ and a cross section of the upper mold along the line F-F′ with glass materials placed on the lower mold;

FIG. 2b is a cross section showing the glass materials pressed by the upper mold and the lower mold;

FIG. 3a is a diagram showing the upper mold and the lower mold being laterally misaligned;

FIG. 3b is a partial cross section showing the upper mold and the lower mold being misaligned and inclined to each other;

FIG. 4 is a schematic diagram showing an apparatus for measuring wavefront aberration of transmitted light for measuring a wavefront aberration of transmitted light;

FIG. 5 is a flow chart showing the steps for manufacturing lenses by using optical element molding dies; and

FIG. 6 is a flow chart showing an adjusting step, in the flow chart of FIG. 5, for adjusting the optical element molding dies.

### BEST MODE FOR CARRYING OUT THE INVENTION

The present invention is described based on embodiments without being limited thereto.

In the field of adjusting the relative positions of the molding dies used to mold an optical lens, as a method for adjusting the relative positions of the molding dies on the basis of the evaluation of the optical performance of the optical element in its intended condition without providing a conventional convex portion, there is proposed a method in which the wavefront aberration of transmitted light of the optical element made by the molding dies is used.

By using the wavefront aberration of transmitted light, it is possible to measure with high precision the misalignment of the relative positions of the opposing optical surfaces of an optical element, thus, the measurement does not take a long time. On the other hand, if the optical element has a shape with which the measurement of the wavefront aberration of transmitted light is difficult or a shape with which the measurement value is small with respect to the misalignment amount of the relative position, in other words, the sensitivity of measurement is low, it is difficult to adjust the relative positions of the molding dies on the basis of the measurement value of the wavefront aberration of transmitted light, thereby the above advantage is not effective.

In the embodiments of the present invention described below, the problems in such reference example can be solved.

### Optical Element Molding Dies

The present invention relates to a method for manufacturing an optical element and molding dies for manufacturing optical elements by a molding method, and is described by using as an example a method (reheat method) for obtaining lenses as optical elements by preparing beforehand a glass material having a predetermined mass and shape, heating the glass material together with the molding dies, and then pressure forming the glass material with the molding dies to obtain the lenses as optical elements.

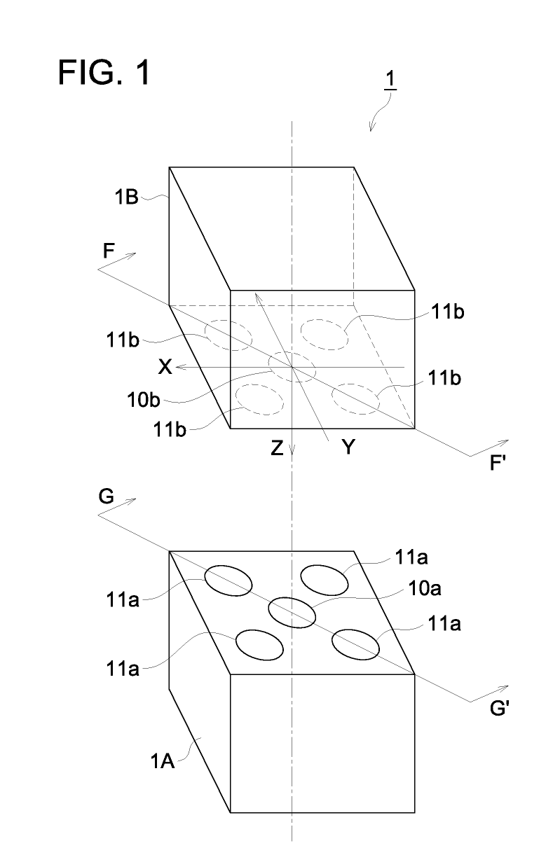

FIG. 1 is a diagram showing a molding die 1, which is a molding die used in a method according to the present invention for manufacturing optical elements. The molding die 1 has a lower mold 1A and an upper mold 1B and presses simultaneously a plurality pieces of glass materials (FIG. 1 shows 5 pieces) to mold lenses, which contain two kinds of optical elements. Any of the two kinds of lenses has a first optical surface and a second optical surface which are opposing each other.

The lower mold 1A has first molding surfaces 10a and 11a precisely machined to have shapes designed to form the first optical surfaces of the lenses, and the upper mold 1B has second molding surfaces 10b and 11b precisely machined to have shapes designed to form the second optical surfaces facing the first optical surfaces.

The upper mold 1B is a movable molding die, which can be moved in a pressing direction (Z direction in FIG. 1) by a not-shown driving section, and the lower mold 1A is a fixed molding die, which is not moved when pressure forming.

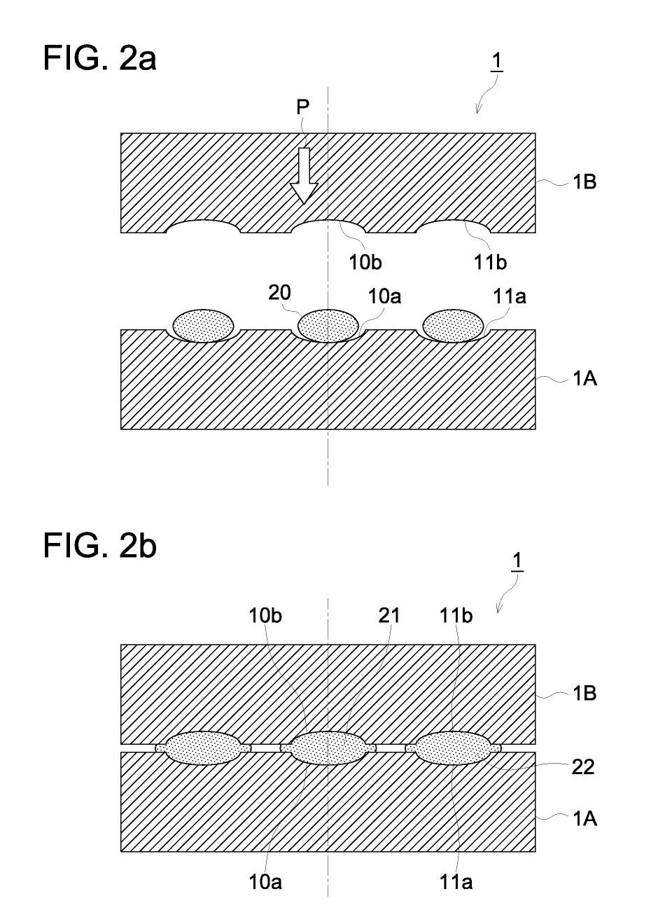

FIG. 2a is a cross section of the lower mold 1A along the line G-G′ and a cross section of the upper mold 1B along the line F-F′ shown in FIG. 1, and a piece of glass material 20 to be molded is placed on each of the first molding surfaces 10a and 11a of the lower mold 1A, and a pressing direction P is shown.

FIG. 2b shows the upper mold 1B having been moved in the pressing direction P to press and mold the softened glass material 20 with the first molding surfaces 10a and 11a of the lower mold 1A and the second molding surfaces 10b and 11b of the upper mold 1B. In this process, the molding die 1 simultaneously molds a lens 21 as a second optical element, with the first molding surface 10a and the second molding surface 10b and lenses 22 as the first optical elements, with the first molding surfaces 11a and the second molding surfaces 11b.

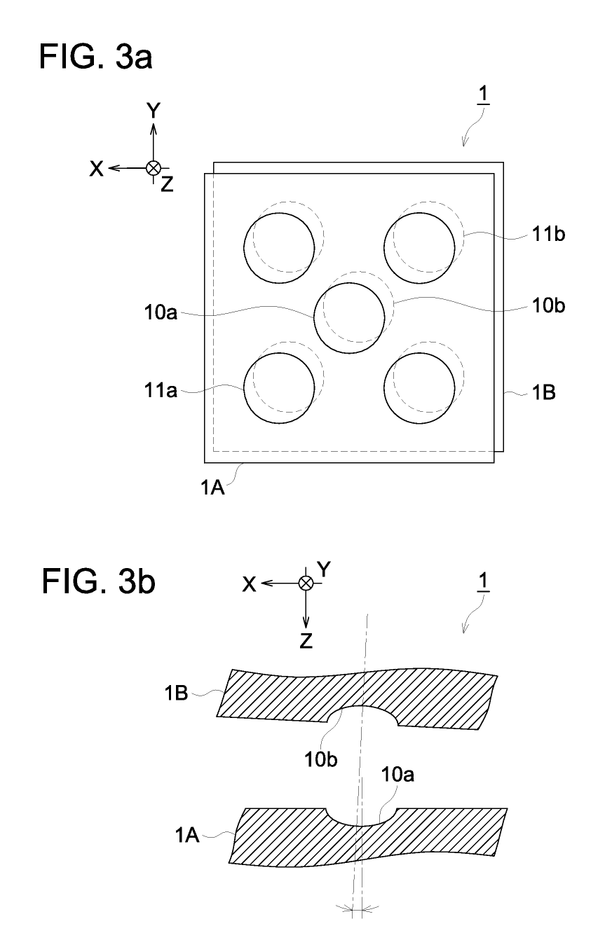

FIGS. 3a and 3b are diagrams schematically showing the lower mold 1A and the upper mold 1B of the molding die 1, the relative position between which molds is misaligned. FIG. 3a shows the lower mold 1A and the upper mold 1B, which are misaligned along the X axis and the Y axis (in the X-Y plane), when viewed from above the upper mold 1B down to the lower mold 1A of FIG. 1. FIG. 3 b shows the upper mold 1B being inclined from the Z axis defined based on the lower mold 1A, in the neighborhood of the first molding surface 10a and the second molding surface 10b of FIG. 2a.

When the upper mold 1B is misaligned in relative position with respect to the lower mold 1A in the X axis and the Y axis (in the X-Y plane) as shown in FIG. 3a, the misalignment of the relative position (parallel eccentricity) is generated with the central axes of the first optical surfaces and the second optical surfaces of the molded lenses 21 and 22 laterally misaligned.

Similarly, when the misalignment of relative position is generated such that the upper mold 1B is rotated with respect to the lower mold 1A along the line perpendicular to the Z axis as shown in FIG. 3b with the central axis of the second molding surface 10b of the upper mold 1B inclined from the Z axis, the misalignment of relative position (inclination eccentricity) is generated with the optical axes of each of the first optical surfaces and each of the second optical surfaces of the molded lenses 21 and 22 inclined from each other.

Thus, if the misalignment amount of relative position between the first optical surface and the second optical surface of any one of the lens 21 and lenses 22 can be measured, the relative position between the lower mold 1A and the upper mold 1B can be adjusted on the basis of the value of the misalignment amount.

In this embodiment, the lens 22 is a targeted optical element (first optical element) to be manufactured (mass produced) by using the molding die 1, and the lens 21 is an optical element (second optical element) to be used to adjust the relative position of the molding die 1 on the basis of the obtained amount of the misalignment of relative position between the first optical surface and the second optical surface.

With reference to the lens 21 as an example, it will be described how the misalignment amount of relative position between the first optical surface and the second optical surface on the basis of the wavefront aberration of transmitted light.

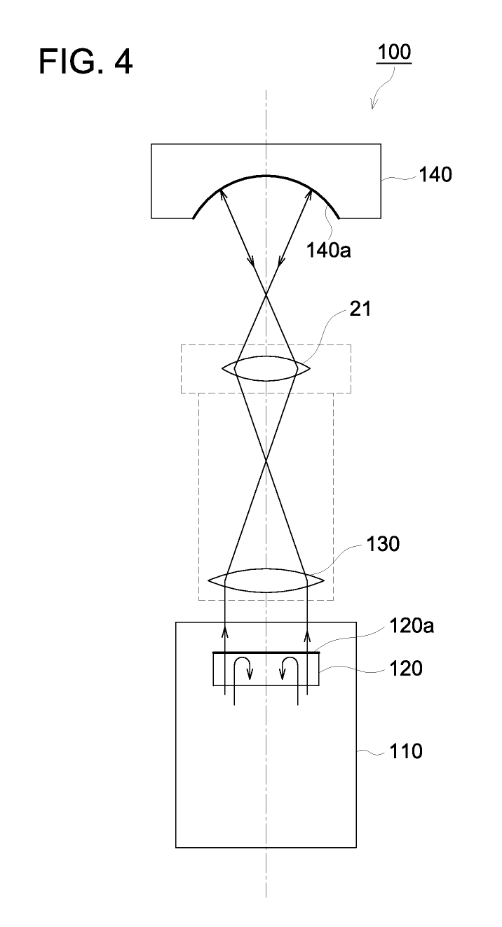

First, the measurement of the wavefront aberration of transmitted light will be described with reference to FIG. 4. FIG. 4 is a schematic diagram showing an apparatus for measuring wavefront aberration of transmitted light 100 for measuring the wavefront aberration of transmitted light of the lens 21, which is the optical element to be used for adjustment, by using a known Fizeau interferometer 110.

In this embodiment, the lens 21 converts the diverging spherical wave into a converging spherical wave, as an example shown in FIG. 4.

In the Fizeau interferometer 110, since it is impossible to interfere a parallel light with the reflected wavefront of a reference plane 120a of a plane plate 120 by using the lens 21 alone, a collimator lens 130 is provided to convert the parallel light into the converging light to fit the lens 21. If the lens 21 converts the plane wave into the converging spherical wave, the collimator lens 130 is not needed.

With reference to FIG. 4, the parallel light exiting from the Fizeau interferometer 110 is once converged by passing through the collimator lens, then diverges and enters the lens 21, and then exits as a converging light. This converging light is reflected by a spherical surface standard 140 equipped with a reference reflective surface 140a having an almost ideal spherical surface which is closest to the designed transmitted wavefront of the lens 21, and returns to the Fizeau interferometer 110 approximately along the light pass on which the light has traveled so far. The collimator lens 130 is preferably made to have a transmitted wavefront having almost the same shape as designed.

On the Fizeau interferometer 110, the light (transmitted wavefront) returning through the lens 21 and the light (standard wavefront) reflected by the reference plane 120a interfere to generate interference fringes. By capturing these interference fringes as an image data by using an imaging element such as a CCD installed in the Fizeau interferometer 110 and by analyzing the interference fringes, using a predetermined image processing, the wavefront aberration of transmitted light of the lens 21 can be measured.

Generally, for performing the analysis of the interference fringes, it is needed that there in no region where the spatial frequency band of the interference fringes is too wide to detect the interference fringe itself, so that an imaging device (not shown) such as a CCD installed in the Fizeau interferometer 110 can resolve the interference fringe with its resolution. Thus, the smaller the wavefront aberration of transmitted light is, the more precisely the interference fringe can be analyzed easily.

The lens 22 is a mass-production optical element, and its specifications are determined depending on its application. On the other hand, the lens 21 is an optical element used to adjust the relative position of the molding die 1, and for this reason there is an advantage that its specifications can be determined so as to more easily and more highly precisely adjust the relative position of the molding die 1 regardless of the specifications of the lens 22.

From the viewpoint of the above-described analysis of the interference fringes, it is preferably that the displacement of the lens 21 from the spherical surface which is closest to the designed transmitted wavefront is smaller than the displacement of the lens 22 from the spherical surface which is closest to the designed transmitted wavefront.

The specifications of the lens 21 may be determined so as to make the displacement small; and the correction lens such as the collimator lens 130 for converting a parallel light so that the wavefront (transmitted wavefront) passing through the lens 21 gets similar to the shape of a reference reflective surface 140a; and the reference reflective surface 140a of a spherical surface standard 140 may be designed as desired. When the lens 21 converts the entering plane wave or spherical wave into the spherical wave having a shape similar to the reference reflective surface 140a of the spherical surface standard 140, the correction lens does not needed or is made in an easily prepared shape, and the reference reflective surface 140a can be in a spherical shape, which is easily prepared. It is a greatly advantageous for obtaining the wavefront aberration of transmitted light of the lens 21 that such correction lens and reference reflective surface can be used.

In addition to the above-mentioned analysis of the interference fringes, also from the viewpoint of the correction lens and the easiness of preparing a spherical surface standard, it is preferable that the displacement of the lens 21 from the spherical surface which is closest to the designed transmitted wavefront is smaller than the displacement of the lens 22 from the spherical surface which is closest to the designed transmitted wavefront.

Next, it will be described how to obtain the misalignment amount of relative position between the opposing first optical surface and second optical surface of the lens 21 on the basis of the wavefront aberration of transmitted light obtained by the analysis of the interference fringes.

As a method for obtaining the misalignment amount of relative position, by measuring the wavefront aberration of transmitted light, of the opposing first optical surface and second optical surface of the lens 21, there is a method, for example, in which the amount of parallel eccentricity (shift amount between surfaces) and the amount of inclination eccentricity (tilt amount between surfaces) is obtained by using the third-order comatic aberration and the fifth-order comatic aberration obtained from the wavefront aberration of transmitted light.

In Zernike coefficients (Z₀ to Z₃₅), the Z₆ represents the third-order comatic aberration in the x axis direction, the Z₇ represents the third-order comatic aberration in they axis direction, the Z₁₃ represents the fifth-order comatic aberration in the x axis direction, and Z₁₄ represents the fifth-order comatic aberration in they axis direction.

On the basis of the design of the lens 21, the following coefficients are obtained: a coefficient a with respect to one minute of tilt between surfaces and a coefficient b with respect to 1 μm of shift between surfaces which determine the value of the Zemike coefficients Z₆ and Z₇; and a coefficient c with respect to one minute of tilt between surfaces and a coefficient d with respect to 1 μm of shift between surfaces which determine the value of the Zemike coefficients Z₁₃ and Z₁₄.

In fact, the wavefront aberration of transmitted light obtained by the apparatus for measuring wavefront aberration of transmitted light 100 is not only for lens 21 but covers the collimator lens 130 used as a correction lens and the reference reflective surface 140a of the spherical surface standard 140. The coefficients with respect to one minute of the tilt between surfaces and with respect to 1 μm of the shift between surfaces a, b, c, and d, which are similar to the case of the lens 21, are obtained on the basis of the design of the optical system made up of the collimator lens 130, the lens 21, and the spherical surface standard 140.

Values tilt_{α}, tilt_{β}, shiftₓ, and shift_{y} are obtained by solving the four variable simultaneous equations of equations (1) to (4) below, which are equations to represent the Zemike coefficients Z₆, Z₇, Z₁₃, and Z₁₄ obtained from the wavefront aberration of transmitted light, using the above-mentioned coefficients a, b, c, and d.

Z₆=a×tilt_{α}+b×shiftₓ (1)

Z₇=a×tilt_{β}+b×shift_{y} (2)

Z₁₃=c×tilt_{α}+d×shiftₓ (3)

Z₁₄=c×tilt_{β}+d×shift_{y} (4)
where: the x axis and they axis are perpendicular to each other and are perpendicular to a reference axis z defined with respect to the optical surface of or the outer circumference of the lens 21;
the tilt α and the tilt β represent tilt amounts (minute) between surfaces around they axis and the x axis, respectively; and
the shift x and the shifty represent the shift amount (μm) between surfaces in the x axis direction and they axis direction, respectively.

The above-mentioned coefficients a, b, c, and d are ratios of the amounts of the generated wavefront aberration of transmitted light to the misalignment amount of relative position of the optical surfaces, and as these ratios are larger, a larger wavefront aberration of transmitted light is generated by a smaller tilt amount between surfaces and a smaller shift amount between surfaces. Such large ratios mean that the measurement sensitivity of the tilt amount between surfaces and the shift amount between surfaces is high; thus, on the basis of the wavefront aberration of transmitted light obtained from the analysis of the interference fringes, a smaller tilt amount between surfaces and a smaller shift amount between surfaces can be obtained, and the relative position of the molding die 1 can be accordingly highly precisely adjusted.

Therefore, it is preferable that the lens 21 has a larger ratio of the amount of the generated wavefront aberration of transmitted light with respect to the misalignment amount of relative position between the opposing optical surfaces than the lens 22. With this arrangement, a smaller tilt amount between surfaces and a smaller shift amount between surfaces can be easily realized by using the lens 21 than by using the lens 22, and with this adjustment, the relative position of the molding die 1 is easily adjusted with high precision, which cannot be realized by using the lens 22. Examples of the lens 21 and lens 22 having different measurement sensitivities will be described below.

The lens 21 is a double aspherical lens, and the above coefficients a, b, c and d are as follows: a=−133 mλ/minute; c=−17 mλ/minute; b=85 mλ/μm; and d=−17 mλ/μm. The lens 22 is a double aspherical lens, and the above coefficients a, b, c, and d are as follows: a=5 mλ/minute; c=0; b=14 mλ/μm; and d=0. The coefficients a, b, c, and d of the lens 21 each have larger absolute value than those of the lens 22. By employing the lens 21 as an optical element for adjustment, the relative position of the molding die 1 can be easily adjusted with higher precision than by employing the lens 22, and the lens 22 is accordingly higher precisely manufactured.

In the above example of obtaining both of the parallel eccentricity amount and the inclination eccentricity amount, both of the parallel eccentricity amount and the inclination eccentricity amount are obtained; however without being limited thereto, the kind of the eccentricity to be obtained may be determined depending on necessity and the lens 21 may be determined depending on the determined eccentricity. For example, the amount of eccentricity to be obtained may be one of the followings: any one of the parallel eccentricity amount and the inclination eccentricity amount; only the parallel eccentricity amount in the x axis direction, in the case of obtaining the parallel eccentricity; only the inclination eccentricity around they axis, in the case of obtaining the inclination eccentricity amount.

In addition, it is preferable to provide, in the lens 21 used as an optical element for adjustment, a mark indicating the relative position with respect to the molding die 1. For example, a cut-out portion or a protrusion portion may be provided on the circumference (for example, a flange) other than the optically effective area of lens 21. With this arrangement, it is easy to see which direction the molding die 1 should be adjusted on the basis of the shift amount between surfaces (parallel eccentricity amount) and the tilt amount between surfaces (inclination eccentricity amount), which have been obtained from the wavefront aberration of transmitted light of the lens 21.

Since the lens 21 is for the adjustment of the relative position of the molding die 1, there is a high degree of freedom in position and shape; thus the mark is easily provided unless the mark affects the measurement of the wavefront aberration of transmitted light.

In general, many lenses are rotationally symmetric around the optical axis, and when a lens is rotationally symmetric around the optical axis, the wavefront aberration of transmitted light generated by the mutual rotation of the first optical surface and the second optical surface around the optical axis is theoretically zero. For this reason, if the lens 21 rotationally symmetric around the optical axis is used as an optical element for adjustment, the adjusted of the misalignment of relative position around the Z axis is impossible with the molding die 1 of FIG. 1.

In order to address the above problem, the lens 21 may by made to have a shape with which the opposing first optical surface and second optical surface are rotationally non-symmetric around the optical axis, for example, the opposing first optical surface and second optical surface each have a toroidal surfaces, which is one of anamorphic surfaces. With this arrangement, the lens 21 generates the wavefront aberration of transmitted light due to the inclination eccentricity caused by the mutual rotation of the first optical surface and the second optical surface around the optical axis, in addition to the parallel eccentricity between the opposing first optical surface and second optical surface; thus the misalignment of the relative position around the z axis of the molding die 1 can be precisely adjusted on the basis of the wavefront aberration of transmitted light.

The material for the lower mold 1A and the upper mold 1B is required to have different properties including being less reactive with glass and less oxidizable even at a high temperature and easiness of forming a good mirror surface. Examples of the materials having these properties include cemented carbide containing tungsten carbide, different ceramics (silicon carbide, silicon nitride, aluminum nitride, and the like) such as carbide and nitride, carbon, or composite of these materials. In addition, these materials may be preferably used with a thin film of different metals, ceramics, or carbon formed on their surface. The upper mold 1B and the lower mold 1A may be made of the same material or different materials.

It is preferable in terms of the precision of the relative position that the first molding surfaces 10a and 11a of the lower mold 1A and the second molding surfaces 10b and 11b of the upper mold 1B are each made to be a single member; however each of the molding surface may be made to have a plurality of members.

### Method for Manufacturing Optical Element

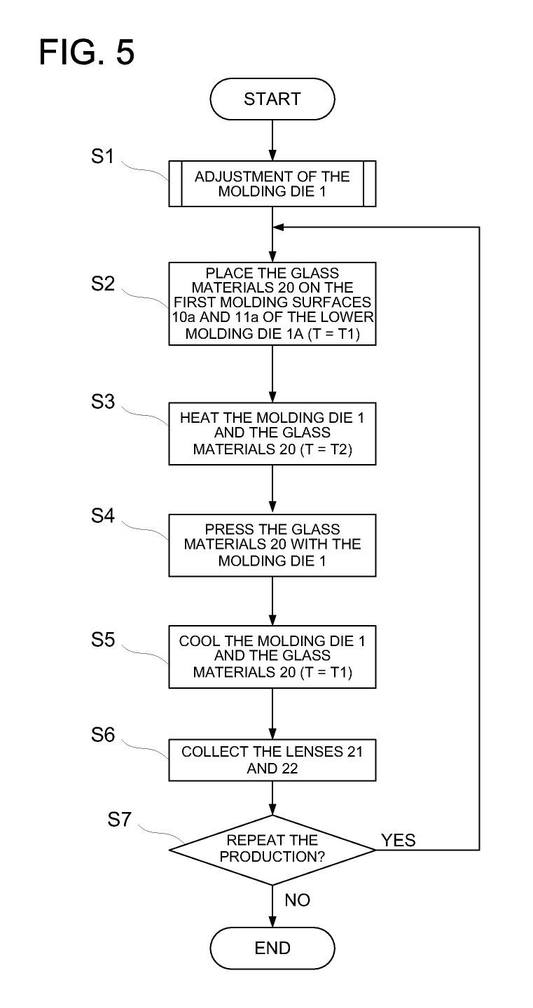

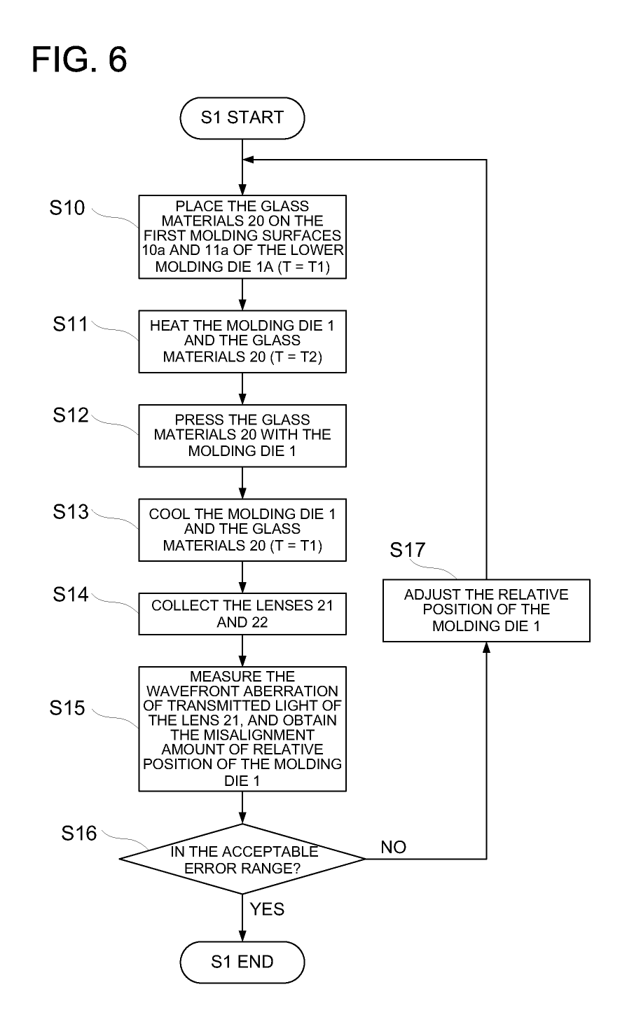

FIG. 5 is a flow chart showing an example of a process of manufacturing the lenses 22 by a method for manufacturing an optical element according to the present invention. FIG. 6 is a flow chart showing the details of the step (step S1 of FIG. 5) of FIG. 5 for adjusting the molding die. In the following, how to manufacture the lenses 22 by using the molding die 1 and a reheat method will be described, occasionally referring to FIG. 1 to FIG. 6.

In the beginning of the manufacturing of the lenses 22, the relative position of the lower mold 1A and the upper mold 1B of the molding die 1 for molding the lenses 22 is adjusted by using the lens 21, which is simultaneously made with the lenses 22 (step S1 of FIG. 5).

In the following, step S1 of FIG. 5 will be described in further detail with reference to the flow in FIG. 6.

With reference to FIG. 6, first the glass materials 20 are placed on the first molding surfaces 10a and 11a of the lower mold 1A, as shown in FIG. 2a, with the upper mold 1B drawn back upward from the lower mold 1A (step S10). The shape of the glass materials 20 may be appropriately determined depending on the shapes of the lens 21 and lens 22 to be made and the like. For example, a sphere, a hemisphere, or a plane may be used.

There is no specific limitation in material for the glass material 20, and known glass can be used depending on application. Examples include optical glasses such as borate silicate glass, silicate glass, phosphate glass, and lanthanum series glass. It is preferable, because of a forming condition, that the shape and the material of glass materials 20 placed on the first molding surfaces 10a and 11a are the same, however they do not need to be the same.

At this time of the process, the temperature T of the molding die 1 is kept at a predetermined temperature T1, which is lower than a temperature T2 for the pressure forming. If the temperature of the molding die 1 is too low, the productivity may be lowered because of longer time needed for heating and cooling. Typically, the temperature may be appropriately set at about the room temperature (25° C.) to the glass transition temperature Tg of the glass material 20.

Next, the molding die 1 and the glass material 20 are heated up to the temperature T2 for the pressure forming by a not-shown heating device (step S11).

The temperature T2 for the pressure forming may be appropriately selected so as to form good transferred surfaces on the glass materials 20 by the pressure forming. In general, if the temperature of the lower mold 1A or the upper mold 1B is too low, it will be difficult to form good transferred surfaces on the glass materials 20. To the contrary, if the temperature is higher than required, the glass materials 20 may be adhered to the molding die 1 or the service life of the molding die 1 may get short.

In practice, the appropriate temperature depends on different conditions: the kind, shape, and size of the glass; the material and kind of the protective layer of the molding die 1; the shape and size of the glass material 20; and the positions of the heater and the temperature sensor; thus the appropriate temperature is preferably determined through experiments.

There is no limit in the heating device, and any known heating device can be used. Examples include an infrared heating device, a high frequency induction heating device, and a cartridge heater. In addition, in order to prevent the members of the molding die 1 from being deteriorated due to oxidization by heating, it is also preferable that the whole of the molding die 1 is sealed and heated in the non-oxidative atmosphere with nitrogen gas or argon gas introduced. It may be heated in a vacuum.

Next, the upper mold 1B is lowered by a not-shown driving means to press the glass material 20 as shown in FIG. 2b (step S12). Through this process, the second molding surfaces 10b and 11b of the upper mold 1B and the first molding surfaces 10a and 11a of the lower mold 1A are transferred onto the glass materials 20, and the two kinds of lenses 21 and 22 having opposing two optical surfaces are simultaneously molded. The pressing force may be appropriately set depending on the size of the glass material 20 and the like. Alternatively, the pressing force may be temporally varied.

There is no limit in the driving means, either, and any known pressing means such as an air cylinder, an oil hydraulic cylinder, and an electric cylinder using a servo motor may be selectively used if necessary.

After that, the molding die 1 and the glass material 20 are cooled down to the initial temperature T1 (step S13). In the cooling process, when the temperature gets down to the temperature at which the transferred surfaces do not deform without the pressure on the glass material 20, the upper mold 1B is released from the glass material 20 to remove the pressure. The temperature at which the pressure is removed depends on the kind of glass, the size and shape of the glass material 20, and a required precision, but in general a temperature around Tg of the glass is used.

After the molding die 1 is cooled down to the initial temperature T1, the upper mold 1B is drawn back upward to collect the lenses 21 and 22 having been manufactured (step S14). The lenses 21 and 22 can be collected by a known releasing device using vacuum suction, for example.

Out of the collected lenses 21 and 22, the wavefront aberration of transmitted light of the lens 21 used as an optical element for adjustment is measured by the apparatus for measuring wavefront aberration of transmitted light 100 shown in FIG. 4. On the basis of the obtained measurement value, the misalignment amount of relative position between the first optical surface and the second optical surface of the lens 21, in other words, the amounts of the misalignment of relative position between the lower mold 1A in which the first molding surface 10a is formed and the upper mold 1B in which the second molding surface 10b is formed (measurement step: step S15); and it is determined whether the obtained amount of the misalignment of relative position is in an acceptable error range (step S16).

If the determination result shows that it is not in the acceptable error range, the relative position between the lower mold 1A and the upper mold 1B is adjusted so that the misalignment amount of relative position falls in the predetermined acceptable error range, on the basis of the misalignment amount of relative position obtained from the measurement value of the wavefront aberration of transmitted light of the lens 21 (relative position adjustment step: step S17).

By adjusting the relative position between the lower mold 1A and the upper mold 1B, the relative position between the first molding surfaces 11a and the second molding surfaces 11b, which are located around the first molding surface 10a and the second molding surface 10b, is simultaneously adjusted.

A molding step (first molding step) from the above-mentioned step S10 to step S14, the measurement step of step S15, and the relative position adjustment step of step S17 are repeated until the misalignment amount of relative position of the molding die 1 is determined to be in the predetermined acceptable error range.

After relative position between the upper mold 1B and the lower mold 1A has been adjusted so that the misalignment amount of relative position of the molding die 1 is in the acceptable error range, the molding step (second molding step) from step S2 to step S6 of FIG. 5 are repeated to successfully mass-produce the lenses 22. The molding steps from step S2 to step S6 are similar to the above-described molding steps from step S10 to step S14, and the description thereof is omitted. In FIG. 6, the lenses 22 are molded along with the lens 21, but there is no need to mold the lenses 22. The manufacturing process of the lenses 22 may include other step than step S1 to step S6. For example, a step of cleaning the molding die 1 may be added after the collection of the lenses 21 and 22, or the adjustment step (step S1) may be added occasionally in the course of returning from the Yes in step S7 to step S2 to confirm the relative position of the molding die 1. In the manufacturing process shown in FIG. 5, the lens 21 is produced along with the lenses 22; however there is no need to mold the lens 21 after the relative position of the molding die 1 has been adjusted.

The method for manufacturing an optical element according to the present invention is not limited to be used only for the method for manufacturing an optical element using the above-described reheat method. The method for manufacturing an optical element according to the present invention can be used for: a liquid drop method in which the upper and the lower molding dies are previously heated to a predetermined temperature, a molten glass material is dropped on the surface of the lower mold, and the glass material is pressure formed with the upper and the lower molding dies while the dropped glass material is hot enough to be deformed; and an injection molding method using plastic material.

### DESCRIPTION OF THE NUMERALS

1: Molding die
1A: Lower mold
1B: Upper mold
10a and 11a: First molding surface
10b and 11b: Second molding surface
20: Glass material
21: Lens (second optical element)
22: Lens (first optical element)
100: Apparatus for measuring wavefront aberration of transmitted light
110: Fizeau interferometer
120: Plane plate
120a: Reference plane
130: Collimator lens
140: Spherical surface standard
140a: Reference reflective surface

1-6. (canceled)

7. A method of manufacturing a first optical element having opposing optical surfaces, comprising steps of:
molding a second optical element by using a pair of molding dies having a pair of first opposing surfaces to mold optical surfaces of the first optical element and a pair of second opposing surfaces to mold the second optical element, the second optical element having a configuration different from a configuration of the first optical element;
measuring an amount of misalignment of a relative position of the opposing optical surfaces of the second optical element based on transmitted wavefront aberration caused by the second optical element molded by the pair of second opposing surfaces; and
adjusting the relative position of the pair of molding dies based on the amount of the misalignment of the relative position measured in the measuring step;
molding the first optical element by using the pair of molding dies, the relative position of which has been adjusted in the step of adjusting the relative position, and
wherein the pair of second opposing surfaces are configured such that the second optical element molded by the pair of second opposing surfaces enables measurement of the amount of the misalignment of the relative position based on the transmitted wavefront aberration with higher degree of precision than the first optical element molded by the pair of first opposing surfaces.

8. The method of claim 7, wherein the pair of second opposing surfaces is configured such that an amount of displacement of the transmitted wavefront, of a plane wave or a spherical wave passing through the second optical element, from a spherical surface closest to a designed transmitted wavefront of the second optical element is less than an amount of displacement of the transmitted wavefront, of a plane wave or a spherical wave passing through the first optical element, from a spherical surface closest to a designed wavefront of the first optical element.

9. The method of claim 7, wherein the pair of second opposing surfaces is configured such that a ratio of an amount of the transmitted wavefront aberration caused by the second optical element to the amount of the misalignment of the relative position of the pair of second opposing surfaces is larger than a ratio of an amount of the transmitted wavefront aberration caused by the first optical element to the amount of the misalignment of the relative position of the pair of first opposing surfaces.

10. The method of claim 7, wherein the transmitted wavefront aberration caused by the second optical element includes an aberration caused by any one of parallel eccentricity and inclination eccentricity of the opposing surfaces of the second optical element; and
wherein the measuring step includes measurement of the misalignment of optical axes of the opposing optical surfaces of the second optical element in a parallel direction based on the aberration caused by the parallel eccentricity, and measurement of the misalignment of the axes in a tilted direction based on the aberration caused by the inclination eccentricity.

11. The method of claim 7, wherein the pair of second opposing surfaces is configured to be rotationally non-symmetric around an optical axis of the second optical element, and wherein the step of measuring includes measurement of a relative displacement between the second opposing surfaces in a direction around the optical axis, based on the transmitted wavefront aberration caused by inclination eccentricity caused by relative rotation of the opposing optical surfaces around the optical axis.

12. A pair of molding dies configured to mold a first optical element having opposing optical surfaces, the dies having molding surfaces for molding the first optical element and the second optical element and being used in the method of manufacturing the first optical element of claim 7.

13. Molding dies configured to mold a first optical element having opposing optical surfaces, comprising:
a pair of first opposing surfaces to mold optical surfaces of the first optical element and;
a pair of second opposing surfaces to mold a second optical element, the second optical element having a configuration different from a configuration of the first optical element;
wherein the second opposing surfaces are configured such that a configuration of the second optical element molded by the pair of second opposing surfaces enables measurement of the amount of the displacement based on the transmitted wavefront aberration with higher degree of precision than the first optical element molded by the pair of first opposing surfaces.

14. The molding dies of claim 13, wherein the pair of second opposing surfaces is configured such that an amount of displacement of the transmitted wavefront, of a plane wave or a spherical wave passing through the second optical element, from a spherical surface closest to the designed wavefront of the second optical element is less than an amount of displacement of the transmitted wavefront, of a plane wave or a spherical wave passing through the first optical element, from a spherical surface closest to the designed wavefront of the first optical element.

15. The molding dies of claim 13, wherein the pair of second opposing surfaces is configured such that a ratio of an amount of the transmitted wavefront aberration caused by the second optical element to the amount of the misalignment of the relative position of the pair of second opposing surfaces is larger than a ratio of an amount of the transmitted wavefront aberration caused by the first optical element to the amount of the misalignment of the relative position of the pair of first opposing surfaces.

16. The molding dies of claim 13, wherein the pair of second opposing surfaces is configured such that the transmitted wavefront aberration caused by the second optical element includes an aberration caused by any one of parallel eccentricity and inclination eccentricity of the opposing surfaces of the second optical element.

17. The molding dies of claim 13, wherein the pair of second opposing surfaces is configured such that the transmitted wavefront aberration caused by the second optical element includes an aberration caused by relative rotation of the opposing optical surfaces around an axis of the second optical element.
